(19) United States
(12) Patent Application Publication
(10) Pub. No.: US 2015/0288469 A1
(43) Pub. Date: Oct. 8, 2015

(54) SYSTEM AND METHOD FOR MANAGING EMERGENCY INFORMATION

(71) Applicant: Peter Shoemaker, Stephenson, VA (US)

(72) Inventor: Peter Shoemaker, Stephenson, VA (US)

(21) Appl. No.: 14/259,722

(22) Filed: Apr. 23, 2014

Related U.S. Application Data
(60) Provisional application No. 61/976,787, filed on Apr. 8, 2014.

(51) Int. Cl. H04H 20/59; H04H 20/72

(52) U.S. Cl. CPC H04H 20/59; H04H 20/72

(57) ABSTRACT

A system for managing emergency information includes a database containing property data, emergency data, and location data. The system further includes a management system having: a receiver that receives the location data from mobile devices, an updater that updates the database with the location data, a user interface that allows emergency service users to access and modify data in the database, and a distributor that retrieves location-specific information from the database relating to a location of a mobile device and sends the retrieved information to that mobile device. The system further includes a mobile device having a location detector that detects a location of the mobile device, a communicator that sends the location to the management system and receives location-specific information from the management system, and a user interface that communicates the location-specific information to a civilian user.

### TECHNICAL FIELD

The system and method described herein generally relate to the field of emergency information management. More specifically, the system and method relate to emergency information management using location tracking functionality.

### BACKGROUND

Emergency service providers such as fire and rescue departments constantly strive to provide proactive solutions to emergency management; however, their responses remain primarily reactive in character. For example, first responders remain poorly informed and not fully prepared to deal with many situations they encounter. Advances in technology have allowed for public and private databases to provide a large amount of information, however the dissemination of this information is lacking, especially for time-sensitive information. There are many situations where problems could have been avoided had such information been easily accessible, and proper planning could have entirely prevented an undesirable outcome.

Conventional systems currently available only provide emergency responders with a name, address, and reason for a call. The problem with this system is that it provides little to no specific information. While first responders may be able to draw conclusions from the provided information, they are still unable to know physical characteristics that will inevitably affect their performance or ability to save lives.

Current systems also do not provide a way for those receiving assistance to inform first responders with updated information prior/during/after an incident. This means that any information regarding a physical structure, its occupant(s), or potentially harmful contents, are unknown to the first responders prior to entry. The first responders must potentially risk their lives in order to obtain such information.

While lack of information is a major flaw with the current system, another issue is the ability to maintain, update, disseminate, and actively plan for emergency situations. Just as buildings and structures are continually being built, existing buildings, structures, and its contents are continually changing. This also means that a majority of emergency service records are outdated and no longer applicable when/if they are required. This also makes emergency planning extremely difficult, especially when a location requires multiple first response units. Multiple emergency plans may have been created, and are likely outdated, which may result in unnecessary responses, threats, or even deaths.

It is apparent that a need exists for a system and method whereby first responders, emergency services, and civilians share information to improve emergency response for all parties involved.

### BRIEF SUMMARY

A system for managing emergency information includes a database containing property data about a plurality of properties within a region, emergency data about ongoing emergencies within the region, and location data about the location of civilian users within the region. The system further includes a management system having: a receiver that receives the location data from mobile devices, an updater that updates the database with the location data, a user interface that allows emergency service users to access and modify data in the database, and a distributor that retrieves location-specific information from the database relating to a location of a mobile device and sends the retrieved information to that mobile device. The system further includes a mobile device having a location detector that detects a location of the mobile device, a communicator that sends the location to the management system and receives location-specific information from the management system, and a user interface that communicates the location-specific information to a civilian user.

In some embodiments, the location-specific information is contained in a push notification, text message, or email. In some embodiments, a civilian user can access and modify the data in the database through a user interface. In some embodiments, a commercial user can access and modify property data pertaining to their property in the database through a user interface. In some embodiments, the property data contains emergency response plans. In some embodiments, the property data contains photographs of interiors of buildings on the properties. In some embodiments, the location-specific information includes a location of an incident near the civilian user . In some embodiments, the location detector in the mobile device is a GPS receiver. In some embodiments, the location detector in the mobile device is a wifi adapter. In some embodiments, the mobile device is a smartphone.

A method of managing emergency information includes: (a) collecting property data in a database about a plurality of properties in a region; (b) collecting emergency data in the database about ongoing emergencies in the region; (c) determining a location of a civilian users mobile device; (d) collecting location data in the database about the location of the mobile device; (e) displaying the location data to an emergency service user; (f) sending location-specific information to the mobile device based on the location data; and (g) displaying the location-specific information on the mobile device.

In some embodiments, the location-specific information is contained in a push notification, text message, or email. In some embodiments, the method further includes the step of: (h) modifying the data in the database based on input from a civilian user. In some embodiments, the method further includes the step of: (h) modifying the property data in the database based on input from an owner of a property. In some embodiments, the property data contains emergency response plans. In some embodiments, the property data contains photographs of interiors of buildings on the properties. In some embodiments, the location-specific information includes a location of an incident near the civilian user. In some embodiments, step (c) is performed using a GPS receiver on the mobile device. In some embodiments, step (c) is performed using a wifi adapter on the mobile device. In some embodiments, the mobile device is a smartphone.

### BRIEF DESCRIPTION OF THE DRAWINGS

FIG. 1 is diagram of one embodiment of the system in active use during an emergency.

FIG. 2 is a diagram of the embodiment of the system shown in FIG. 1 in active use during an emergency.

FIG. 3 is a representation of a user interface for emergency services users of the management system of embodiment shown in FIG. 1.

FIG. 4A is a representation of a user interface for civilian users of the management system of embodiment shown in FIG. 1 showing information about a civilian user's home.

FIG. 4B is a representation of a user interface for civilian users of the management system of embodiment shown in FIG. 1 showing information about a civilian user's current location.

FIG. 5 is a diagram of one embodiment of a method consistent with the embodiment shown in FIG. 1.

### DETAILED DESCRIPTION

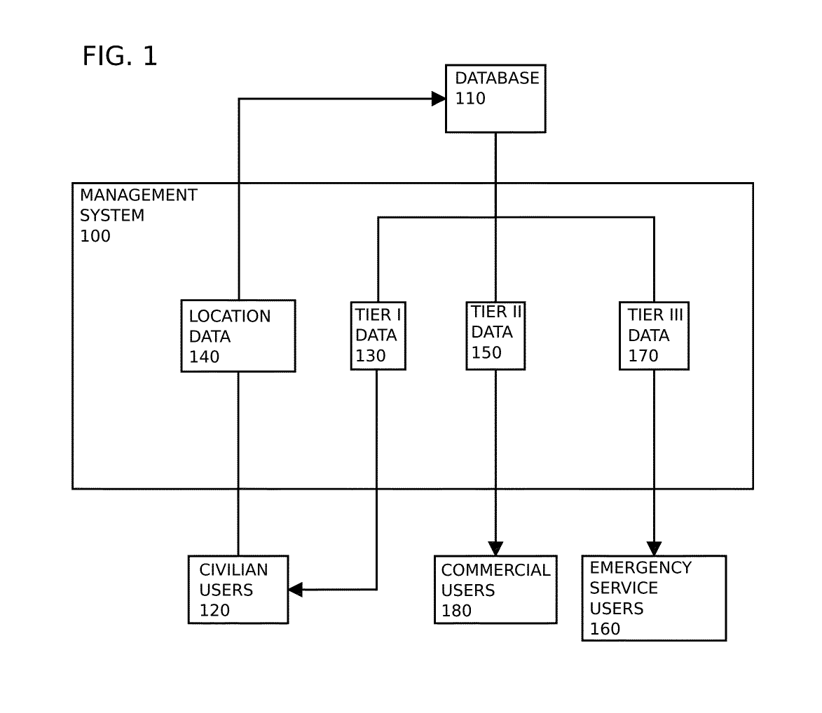

FIG. 1 is diagram of one embodiment of the system in active use during an emergency. Database 110 contains information about properties within a region, information about ongoing emergencies, and locations of civilian users 120. Database 110 may be a single database or a collection of databases.

Management system 100 provides information from database 110 to users, and updates information in database 110. Management system 100 controls access to information within database 110 based on the type of user requesting the information. For example, civilian users 120 can access tier I data 130, which would usually contain information about the civilian users 120 home and current location. Such information could include information about ongoing emergencies in either location, emergency plans, floorplans, etc . . . Commercial users 180 have access to tier II data 150, which includes information about their property and ongoing emergencies there. Emergency service users 160 have access to tier III data 170 which includes all of the information in the system, including the location of civilian users 120.

Management system 100 regularly updates database 110 with current location data 140 for the civilian users 120. This allows civilian users 120 to get pertinent information about emergencies in their location, and allows emergency service users 160 to determine the location of civilian users 120 in areas experiencing an emergency.

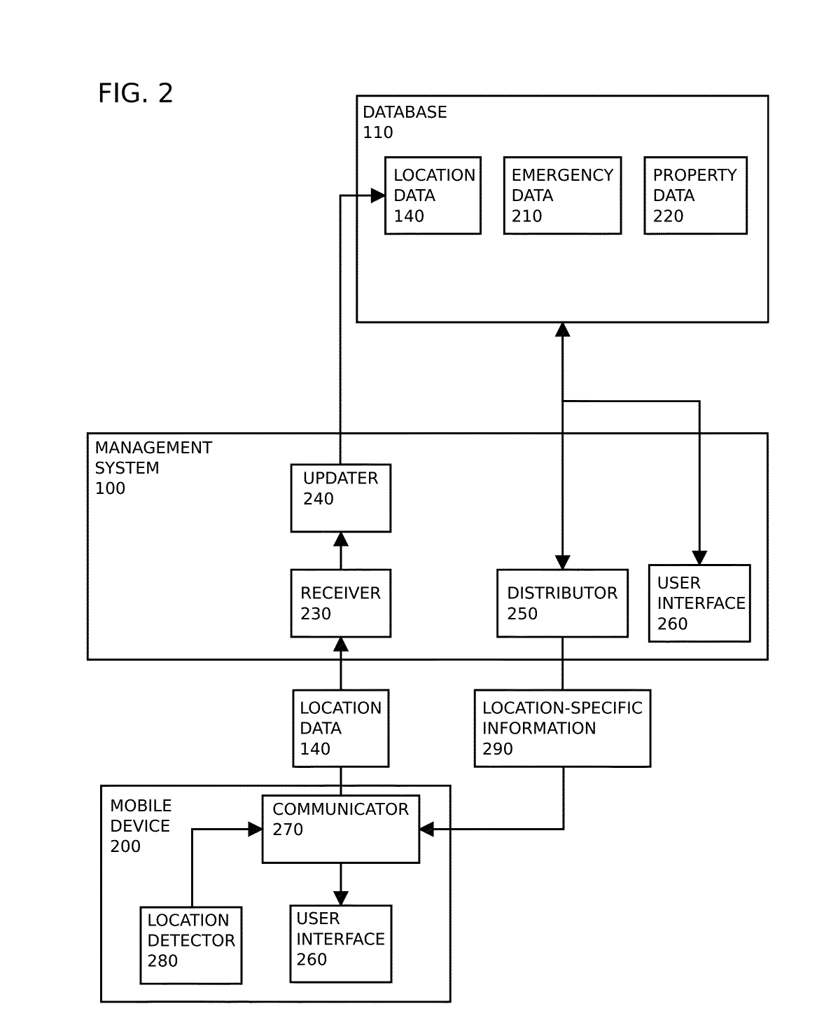

FIG. 2 is a diagram of the embodiment of the system shown in active use during an emergency. As mentioned previously, database 110 contains location data 140, emergency data 210, and property data 220. Database 110 is updated and accessed by management system 100. Management system 100 comprises a user interface 260, which allows users to access and modify data in database 110.

Users, such as civilian users 120 access the system using a mobile device 200. In some embodiments, mobile device 200 is a smartphone running an application that allows civilian user 120 to access management system 100. Mobile device 200 comprises a location detector 280, a user interface 260, and a communicator 270. Location detector 280 detects a location of mobile device 200. In some embodiments, location detector 280 is a GPS receiver or a wifi adapter. Once the location is detected, mobile device 200 sends location data 140 to management system 100 via communicator 270. In some embodiments, communicator 270 is uses wireless communication system such as GSM, CDMA, 802.11, 3G, LTE, etc . . .

After management system 100 receives location data 140 using receiver 230, it uses updater 240 to update database 110 with the current location of mobile device 200. With the up-to-date location of mobile device 200, management system 100 can send location-specific information 290 to mobile device 200 using distributor 250. Location-specific information 290 may include information about an ongoing emergency in the area, the status of the emergency response, and emergency response plans for the area or facility where mobile device 200 is located. Location-specific information 290 may be sent to mobile device 200 in the form of a push notification, text message, or email.

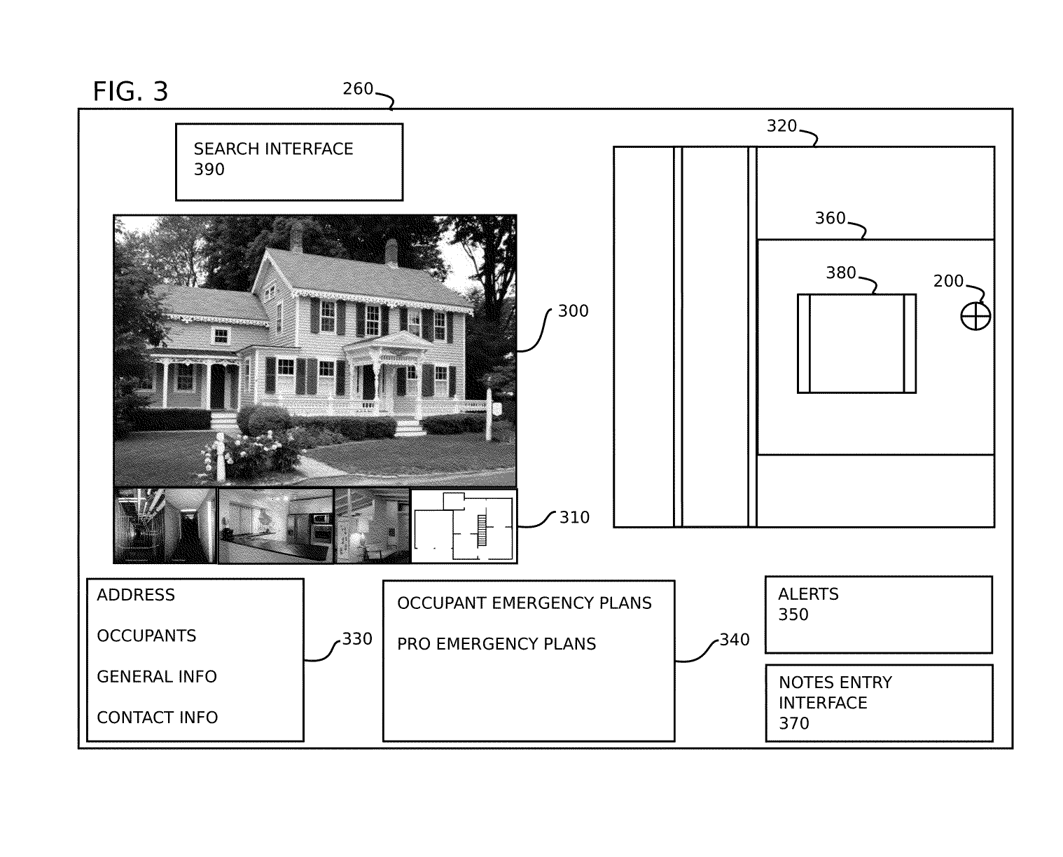

FIG. 3 is a representation of a user interface 260 for emergency services users 160 of management system 100. In this embodiment, user interface 260 comprises a photo viewing window 300, a photo gallery window 310, a map window 320, an information window 330, an emergency plans window 340, an alerts window 350, a notes entry interface 370, and a search interface 390. Search interface 390 allows emergency service users 160 to search for properties based on identifying information, such as address. Once a property 360 has been selected, all of the information in the remainder of the window is provided.

In this embodiment, photo gallery window 310 includes photos of the interior of residence 380, along with a floorplan of residence 380. The photo gallery depicted in photo gallery window 310 may include exterior photos, photos of other structures on property 360, schematics for buildings on property 360, or other pertinent graphical information. Photo gallery window 310 allows users (in this case, emergency services users 160) to scroll through and select photos to view in photo viewing window 300. In this embodiment, photo viewing window 300 features an exterior photo of residence 380.

Map window 320 allows users to see an aerial view of property 360. Map window 320 may contain aerial photographs and map data from publicly available sources such as Google Maps™. Map window 320 shows the location of mobile device 200 on property 360. This is possible because of the location data 140 that management system 100 regularly collects from mobile devices 200. Since civilian users 120 will frequently have mobile devices 200 on their person, map window 320 will show the location of civilian users 120. In this embodiment, mobile device 200 (and likely civilian user 120) is in the back yard of residential property 360. An emergency services user 160 (such as a fire and rescue department) viewing map window 320 during a fire would be able to inform first responders that civilian user 120 is in the back yard of property 360, and rescuing civilians from residence 380 may not be necessary.

Information window 330 contains basic information about the property 360 being viewed. In this embodiment, information window 330 contains the address, list of occupants, general information about the property such as its size, and contact information such as phone numbers and emails of the occupants. This information allows emergency services users 160 to contact the occupants to better coordinate their emergency response.

Emergency plans window 340 gives the emergency service users 160 access to the emergency plans for the property 360. These include emergency plans that the occupants have developed and entered into database 110, as well as emergency services or professional emergency plans that have been entered into database 110. Easy access to this information allows first responders to determine what actions they need to take, as well as what actions may have already been taken by the occupants.

User interface 260 also includes notes entry interface 370 in this embodiment. Notes entry interface 370 allows emergency services users 160 to input and view additional information about property 360 in database 110. Notes entry interface 370 allows users 160 to categorize notes as occupant notes, professional notes, or on-scene notes, and includes categories such as HazMat, biological, or chemical to further organize the information.

User interface 260 also includes alerts 350. Alerts 350 can include any important information about property 360 that should be brought to the attention of emergency services users 160. Alerts 350 may include information about an ongoing emergency on property 360. Alerts 350 may also include non-emergency information, such as information about unique hazards on the property 360. Such information could include: the presence of vinyl siding or a gas line, the presence of architectural features associated with to the developer of property 360, the proximity of neighbors, the number of phones, and the location of staircases.

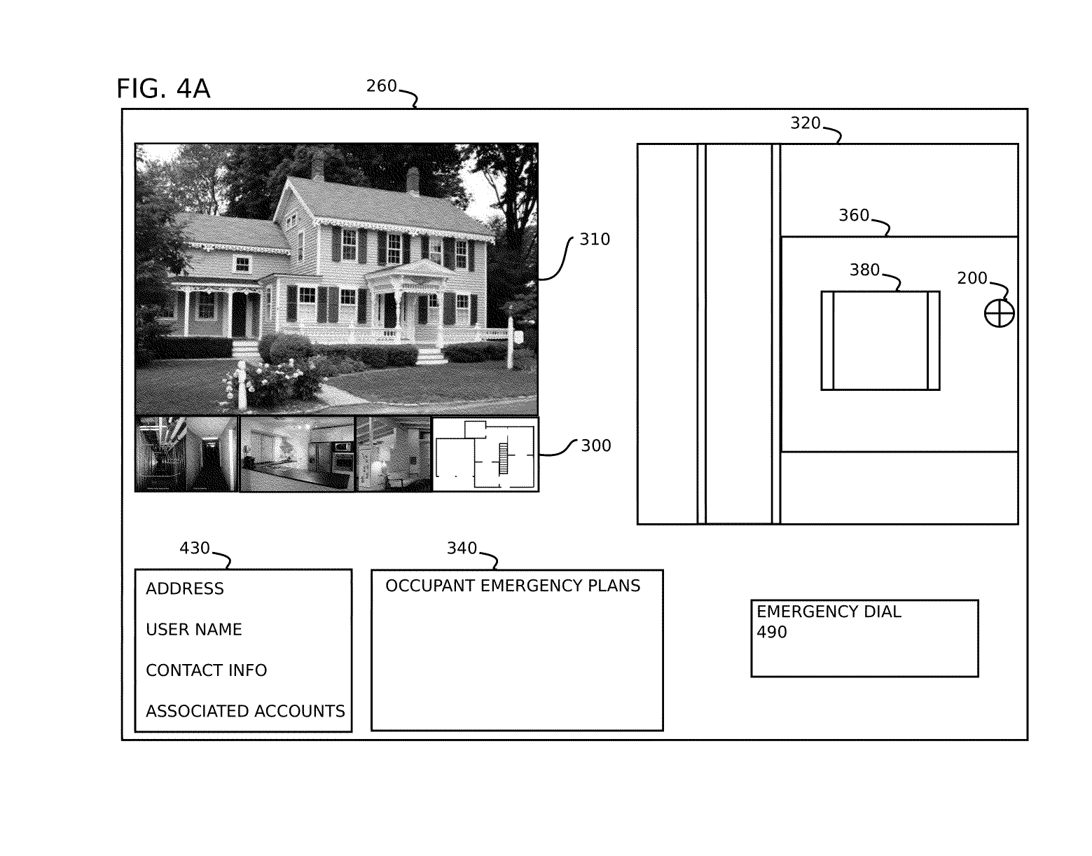

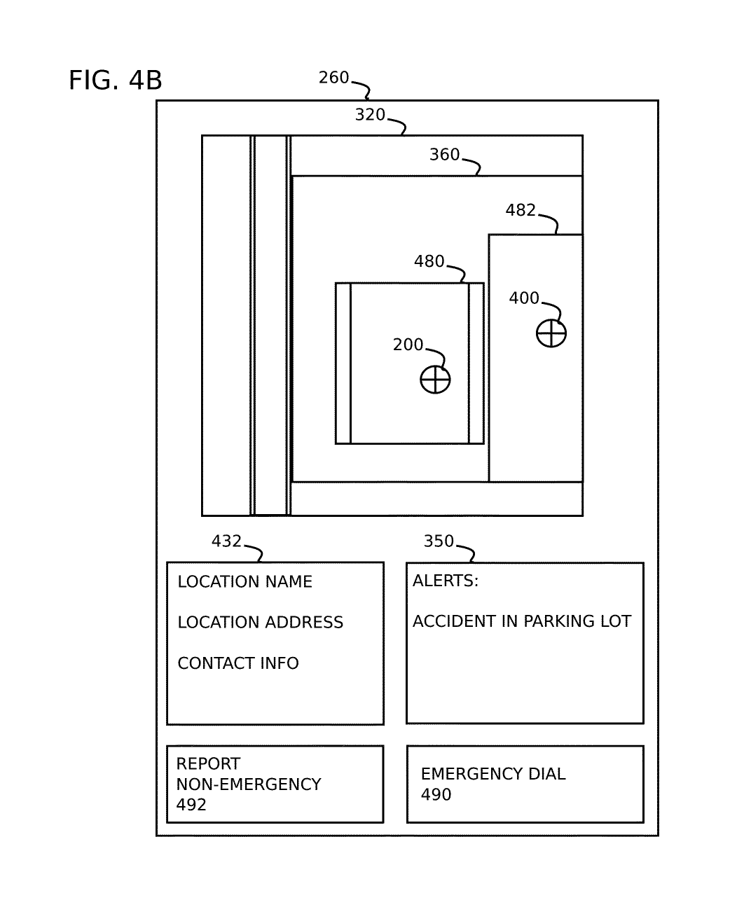

FIG. 4A is a representation of a user interface 260 for civilian users 120 of the management system 100 showing information about a civilian user's 120 home. The civilian home user interface 260 comprises the photo viewing window 300, photo gallery window 310, map window 320, and emergency plans window 340 discussed above. Civilian user 120 can upload photos into the photo gallery shown in photo gallery window 310 through this interface 260. Civilian user 120 can also update the occupant emergency plans in emergency plans window 340 through this interface 260. Occupant emergency plans will usually contain information about an emergency staging location, the individuals who will go there in an emergency, and what type of emergency would trigger the implementation of the plan. The civilian home user interface 260 also includes a user profile window 430 with the user's personal and profile information—including address, user name, contact info, and associated accounts information. Finally, the interface 260 in this embodiment includes an emergency dial button 490, that allows a civilian user 120 using this interface 260 to quickly call emergency services.

FIG. 4B is a representation of a user interface 260 for civilian users 120 of the management system 100 showing information about a civilian user's current location. The civilian location user interface 260 comprises map window 320, alerts window 350, and emergency dial button 490 discussed above. In this embodiment, civilian user 120 is at a mall 480, and a car accident 400 has recently occurred in the parking lot 482 on the mall property 360. Map window 320 shows the location of mobile device 200 that civilian user 120 is using inside mall 480. This is possible because of the location data 140 that management system 100 regularly collects from mobile devices 200. Since someone has reported an incident 400 in parking lot 482, interface 260 shows the location of the incident 400 in map window 320. Alerts window 350 has a description of the incident.

The location user interface 260 shows information about the current location in location information window 432, and also includes a report non-emergency button, so that civilian user 120 can report an incident that is not an emergency without disrupting emergency lines. These features are advantageous to civilian users 120 because it allows them to avoid an incident 400 or render aid. It is beneficial to emergency services users 160 because it gives civilian users 120 an ability to update and/or supplement the information available to emergency service users 160.

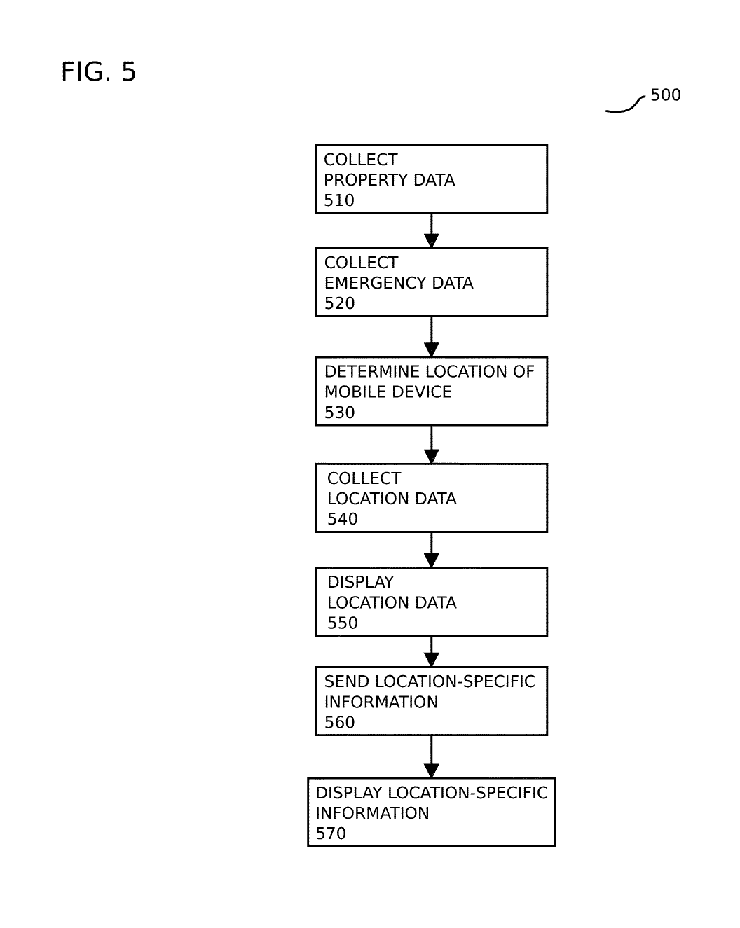

FIG. 5 is a diagram of a method 500 of managing emergency information. The method includes: (a) collecting property data in a database about a plurality of properties in a region (510); (b) collecting emergency data in the database about ongoing emergencies in the region (520); (c) determining a location of a civilian user's mobile device (530); (d) collecting location data in the database about the location of the mobile device (540); (e) displaying the location data to an emergency service user (550); (f) sending location-specific information to the mobile device based on the location data (560); and (g) displaying the location-specific information on the mobile device (570).

Although the invention has been described with reference to embodiments herein, those embodiments do not limit the invention. Modifications to those embodiments or other embodiments may fall within the scope of the invention.

What is claimed is:

1. A system for managing emergency information comprising:
a database containing property data about a plurality of properties within a region, emergency data about ongoing emergencies within the region, and location data about the location of civilian users within the region;
a management system having:
a receiver that receives the location data from mobile devices;
an updater that updates the database with the location data;
a user interface that allows emergency service users to access and modify data in the database; and
a distributor that retrieves location-specific information from the database relating to a location of a mobile device and sends the retrieved information to that mobile device; and
a mobile device having:
a location detector that detects a location of the mobile device;
a communicator that sends the location to the management system and receives location-specific information from the management system; and
a user interface that communicates the location-specific information to a civilian user.

2. The system of claim 1, wherein the location-specific information is contained in a push notification, text message, or email.

3. The system of claim 1, wherein a civilian user can access and modify the data in the database through a user interface.

4. The system of claim 1, wherein a commercial user can access and modify property data pertaining to their property in the database through a user interface.

5. The system of claim 1, wherein the property data contains emergency response plans.

6. The system of claim 1, wherein the property data contains photographs of interiors of buildings on the properties.

7. The system of claim 1, wherein the location-specific information includes a location of an incident near the civilian user.

8. The system of claim 1, wherein the location detector in the mobile device is a GPS receiver.

9. The system of claim 1, wherein the location detector in the mobile device is a wifi adapter.

10. The system of claim 1, wherein the mobile device is a smartphone.

11. A method of managing emergency information, comprising:
(a) collecting property data in a database about a plurality of properties in a region;
(b) collecting emergency data in the database about ongoing emergencies in the region;
(c) determining a location of a civilian user's mobile device;
(d) collecting location data in the database about the location of the mobile device;
(e) displaying the location data to an emergency service user;
(f) sending location-specific information to the mobile device based on the location data; and
(g) displaying the location-specific information on the mobile device.

12. The method of claim 11, wherein the location-specific information is contained in a push notification, text message, or email.

13. The method of claim 11, further comprising the step of:
(h) modifying the data in the database based on input from a civilian user.

14. The method of claim 11, further comprising the step of:
(h) modifying the property data in the database based on input from an owner of a property.

15. The method of claim 11, wherein the property data contains emergency response plans.

16. The method of claim 11, wherein the property data contains photographs of interiors of buildings on the properties.

17. The method of claim 11, wherein the the location-specific information includes a location of an incident near the civilian user.

18. The method of claim 11, wherein step (c) is performed using a GPS receiver on the mobile device.

19. The method of claim 11, wherein step (c) is performed using a wifi adapter on the mobile device.

20. The method of claim 11, wherein the mobile device is a smartphone.
